(19) United States
(12) Patent Application Publication
(10) Pub. No.: US 2013/0216847 A1
(43) Pub. Date: Aug. 22, 2013

(54) STARTING MATERIAL FOR A SINTERED BOND AND PROCESS FOR PRODUCING THE SINTERED BOND

(71) Applicants: Daniel Wolde-Giorgis, Filderstadt (DE); Andrea Feiock, Pliezhausen (DE)

(72) Inventors: Daniel Wolde-Giorgis, Filderstadt (DE); Andrea Feiock, Pliezhausen (DE)

(73) Assignee: ROBERT BOSCH GMBH, Stuttgart (DE)

(21) Appl. No.: 13/880,966

(22) PCT Filed: Sep. 23, 2011
(86) PCT No.: PCT/EP2011/066620

§ 371 Date: Apr. 22, 2013

(30) Foreign Application Priority Data
Oct. 20, 2010 (DE) 10 2010 042 721.7

(51) Int. Cl. B23K 35/24; B32B 7/12; B23K 1/00

(52) U.S. Cl. CPC B23K 35/24; B23K 1/0016; B32B 7/12
USPC 428/553; 75/252; 228/101; 228/248.5; 403/270

(57) ABSTRACT

The invention relates to a starter material for a sintering compound, said starter material comprising first particles of at least one metal having a first coating which is applied to the first particles and consists of an organic material, and second particles which contain an organic metal compound and/or a precious metal oxide, the organic metal compound and/or the precious metal oxide being converted during heat treatment of the starter material into the fundamental elemental metal and/or precious metal. The invention is characterized in that the second particles have a core of at least one metal and a second coating which is applied to the core and contains the organic metal compound and/or precious metal oxide. Furthermore, the first coating contains a reducing agent by means of which the organic metal compound and/or the precious metal oxide is/are reduced to the elemental metal and/or precious metal at a temperature below the sintering temperature of the elemental metal and/or precious metal.

### BACKGROUND OF THE INVENTION

The invention relates to a sintered bond, a starting material for this and a process for producing it, and also an electronic circuit containing the sintered bond.

Power electronics are used in many fields of technology. Especially in electrical or electronic appliances in which large currents flow, the use of power electronics is indispensable. The currents necessary in power electronics lead to thermal stressing of the electrical or electronic components present therein. Further thermal stress is caused by the use of such electrical or electronic appliances in places of operation having a temperature which is significantly above room temperature. Examples which may be mentioned are control instruments in the automobile sector which are arranged directly in the engine compartment. Here, the control instrument is additionally subjected to continual changes in temperature, as a result of which the electrical and/or electronic components therein are subjected to great thermal stresses. In general, temperature changes in the range up to a temperature of 200 degrees Celsius are usual. However, use temperatures going beyond this are also increasingly required. This leads to overall increased demands being placed on the reliability and the functional reliability of electrical or electronic instruments having power electronics.

Joining of electrical or electronic components, for example to a support substrate, is usually effected by means of a bonding layer. Known examples of such a bonding layer are solder bonds, for example composed of tin-silver or tin-silver-copper. At relatively high use temperatures, lead-containing solder bonds can be used. However, lead-containing solder bonds are greatly restricted in respect of their permissible industrial applications by legal obligations for reasons of environmental protection. An alternative for use at elevated or high temperatures, in particular above 200 degrees Celsius, are lead-free hard solders. Lead-free hard solders generally have a melting point above 200° C. A problem is that when hard solder is used for forming a bonding layer, only few electrical or electronic components are possible as join partners which can withstand the high temperatures during melting of the hard solders.

Use is also made of sintered bonds which can be processed at low temperatures and are nevertheless suitable for operation at elevated temperatures. Thus, the patent application DE102007046901A1 discloses such sintered bonds. To produce a sintered bond, a paste-like starting material comprising readily decomposable silver compounds and also silver flocs or nanosilver is used. Furthermore, copper, for example, can be present in the starting material. To form the paste, solvents are mixed in. When the starting material is thermally treated at below 300° C., the silver compounds decompose to form elemental silver and together with the silver flocs and the nanosilver form the sintered bond. The sintered bond is used for contacting two elements. Contacting can be effected at low contact pressures of the contact partners when using the starting material described.

DE 60221433 T2 discloses a sintered bond which is produced from a paste containing particles of a silver compound. Apart from the particles of the silver compound, a reducing agent is also present in dissolved form. In the thermal treatment of the silver paste below 200° C., the silver compound is reduced to elemental silver to form the sintered bond.

U.S. Pat. No. 6,951,666 discloses the production of various sintered bonds. Here, general possible combinations of various starting elements are described. Starting elements mentioned are, inter alia, molecular metals, numerous metallic particles in the nanometer or micron size range, coatings, solvents, additives, reducing agents, crystallization inhibitors, wetting agents and more.

### SUMMARY OF THE INVENTION

### Advantages

It is an object of the invention to provide a starting material for a sintered bond, by means of which a sintered bond can be produced in a simple way at low processing temperatures and pressures.

This object is achieved by a sintered bond, a starting material for this and a process for producing it, and also by an electronic circuit containing the sintered bond.

The starting material of the invention for a sintered bond comprises first particles composed of at least one metal having a first coating which is applied to the first particles. Furthermore, the starting material has second particles which contain an organic metal compound and/or or a noble metal oxide, where the organic metal compound and/or the noble metal oxide are converted in a thermal treatment of the starting material into the parent elemental metal and/or noble metal. The invention is characterized in that the second particles comprise a core of at least one metal, and a second coating which is applied to the core and contains the organic metal compound and/or the noble metal oxide. Furthermore, the first coating applied to the first particles contains a reducing agent by means of which the organic metal compound or noble metal oxide present in the second coating are reduced to the elemental metal and/or noble metal at a temperature below the sintering temperature of the elemental metal and/or noble metal.

The first and/or second coating advantageously in each case encloses the first particles or the metallic core of the second particles essentially completely, but at least virtually completely. As a result, the first and/or second coating in each case acts as a protective shell by means of which it can be ensured that the first particles and the proportion of organic metal compound and/or noble metal oxide present in the second coating remains chemically unchanged. The first and second particles or the starting material comprising the first and second particles can thus be stored until production of a sintered bond.

As a result of the first coating on the first particles, the reducing agent present in the first coating is distributed very uniformly and finely both on the first particles themselves and also overall in the starting material. The reduction process taking place during a thermal treatment of the starting material can therefore occur uniformly within the starting material. This results in the advantage that a sintered bond produced from the starting material of the invention has a very homogeneous sintered microstructure.

Due to application in the form of a first coating to the first particles, the reducing agent is advantageously also positioned as reducing partner as close as possible to the second particles, in particular to the proportion of organic metal compound and/or noble metal oxide therein which is present in the second coating. As a result, the reduction process proceeds in a particularly optimized manner. In addition, the conversion of the organic metal compound and/or the noble metal oxide into the parent elemental metal or noble metal proceeds very quickly since the reduction process in the starting material is restricted to only the second coating. This is aided further, the lower the layer thickness of the second coating. The metallic core therefore advantageously makes up a large proportion of the volume of the second particles, while on the other hand the second coating having a particularly low coating layer thickness makes up a comparatively small proportion of the second particles. Here, it is particularly advantageous that this additionally produces conditions which, when a sufficient amount of reducing agent is present, lead to conversion of virtually all, preferably all, of the organic metal compound and/or noble metal oxide present in the second coating in the starting material to the elemental metal or noble metal. A particularly high thermal and/or electrical conductivity of the sintered bonds produced from the starting material of the invention is then advantageously obtained. In addition, only small amounts of gaseous by-products are obtained as a result of the reduction process.

The first particles present in the starting material preferably contain a noble metal and/or copper. Noble metals particularly preferably used are silver, gold, platinum and/or palladium.

The second particles present in the starting material preferably comprise a second coating, in which the organic metal compound and/or the metal oxide present have the same metallic basis as the first particles and/or the metallic core of the second particles. However, it is likewise conceivable for the metallic basis of the organic metal compound or the noble metal oxide in the second coating to differ from the material of the first particles and/or the metallic core of the second particles.

A further advantageous possibility is to provide variations of second particles in the starting material, which differ in respect of their metallic core and/or in respect of their second coating applied to the metallic core. Thus, as a variation, second particles having a core composed of a first metal and second particles having a core of at least one second metal can be present in the starting material. Furthermore, a further variation of the second particles can be present in the starting material, wherein second particles having a metallic core and a first coating composed of at least one first organic metal compound and/or a first noble metal oxide applied to this core and second particles having a metallic core and a first coating composed of at least one second organic metal compound and/or at least one second noble metal oxide applied to this core are provided.

In an advantageous form of the second particles, the metallic core is essentially formed of copper or a noble metal. A metallic core composed of silver, gold, platinum and/or palladium is particularly advantageous. Furthermore, such a core of the second particles is preferably provided with a coating composed of silver or silver oxide.

In a further advantageous form of the second particles, a silver carbonate, a silver lactate, a silver stearate or a sodium carbonate as organic metal compound and/or silver oxide as noble metal oxide can be present in the second coating. In principle, in this further advantageous form of the second particles, the organic metal compounds and the preferred noble metal oxide are reduced to silver in a thermal treatment of the starting material. As a result, the sintered bond formed in this way from the starting material has a particularly high thermal and/or electrical conductivity.

In a further embodiment of the invention, the first coating containing a reducing agent which is applied to the first particles advantageously comprises at least one organic material as reducing agent, in particular at least one alcohol from the group consisting of primary and secondary alcohols and/or an amine and/or formic acid. Furthermore, it is particularly advantageous for the reducing agent to contain a fatty acid, in particular an isostearic acid, a stearic acid, an oleic acid, a lauric acid, or a mixture of various fatty acids. The first coating provided according to the invention which contains a reducing agent can also be formed exclusively by the reducing agent itself, in particular by the abovementioned reducing agents.

Overall, such first coatings containing a reducing agent can be applied in a simple way to the first particles. In addition, the reducing agents mentioned display a particularly good reducing action in respect of the organic metal compounds or noble metal oxides present in the second coating of the second particles during a thermal treatment of the starting material to form a sintered bond.

Basically, the organic metal compounds or noble metal oxides are converted at high temperatures into the parent elemental metal or noble metal. When using a first coating containing a reducing agent, the conversion of the organic metal compound present in the second coating and/or the noble metal oxide into the elemental metal and/or noble metal advantageously occurs at low processing temperatures. In particular, the elemental metal and/or noble metal is formed in a thermal treatment of the starting material below the sintering temperature of the elemental metal and/or noble metal. This advantageously makes it possible for the join partners joined by the sintered bond formed, for example electrical and/or electronic components of an electronic circuit, not to be subjected to high temperatures during the formation of the sintered bond. Thus, heat-sensitive electrical and/or electronic components in electronic circuits, which have not been able to be used because of the otherwise usual excessively high process temperatures in production of the bond, can be electrically and/or thermally contacted.

Overall, the starting material of the invention displays a very high degree of conversion of up to 99% or more of the organic metal compounds and/or noble metal oxides present in the second coating into the elemental metal and/or noble metal. An at least virtually complete conversion can, in particular, be achieved when the proportion of organic metal compound and/or noble metal oxide is in an essentially stoichiometric ratio to the proportion of the reducing agent in the first coating containing a reducing agent. Amounts which have not been converted, which can otherwise remain in the sintered bond because of an insufficient amount of reducing agent, can reduce the thermal conductivity of the sintered bond.

Since, owing to the stoichiometric ratio, an excess of reducing agent is ruled out, the formation of a sintered bond from the starting material can alternatively be carried out under reduced pressure or in a protective gas atmosphere. If, on the other hand, an excess of reducing agent is present, it is necessary to supply oxygen, e.g. in the form of air, in order to burn out the reducing agent completely.

In a further embodiment of the starting material of the invention, further particles containing an element of the fourth main group of the Periodic Table are advantageously additionally provided. These further particles can contribute to setting advantageous properties of the sintered bond formed from the starting material.

A first possibility is preferably to mix further particles composed of silicon into the starting material. Silicon is added, for example, as filler to the starting material, as a result of which the coefficient of thermal expansion of a sintered bond formed from the starting material is reduced. In addition, silicon has a high electrical conductivity. Particles composed of silicon are also added to the starting material as inexpensive alternatives to silver or to silver compounds. In this way, the proportion of silver in the starting material can be kept low. Fundamentally, particles composed of silicon are advantageously inert during a thermal treatment of the starting material to form a sintered bond. Thus, particles composed of silicon are present in unchanged form within a matrix of the conversion products composed of metal and/or noble metal in a sintered bond formed.

Another possibility is, likewise preferably, to add further particles composed of tin and lead to the starting material. In a thermal treatment of the starting material, tin and lead form alloys with the conversion products composed of metal and/or noble metal which are formed as a result of the reduction process which takes place. These alloys have a melting point lower than that of the metal and/or noble metal, as a result of which the processing temperature to form the sintered bond can be reduced further. In addition, the alloys are then present as ductile phases within the sintered microstructure formed, as a result of which the sintered bonds formed are less susceptible to thermal and/or mechanical stresses, in particular changing stresses. Furthermore, tin, for example, has a low melting point, so that the particles of tin melt at an early juncture in a thermal treatment of the starting material and bring about adhesive contact of all particles present in the starting material. This advantageously promotes the diffusion processes proceeding during the sintering process.

In a further embodiment of the invention, the further particles additionally have a further coating. The further coating, for example of a noble metal, brings about an overall improvement in the sintering of the further particles within the sintered microstructure of a sintered bond formed from the starting material. Thus, for example, further particles are preferably coated with silver and/or gold.

It is in principle advantageous for the first, second and further particles present in the starting material to have an average particle size of 0.01-50 μm, particularly preferably 0.1-10 μm. As a result of the relatively large specific surface area, these particles have an increased reactivity. In this way, the processing temperature and processing time necessary to form a sintered bond can be kept low.

Furthermore, the first, second and further particles are preferably spherical and/or platelet-like. A mixture of such particle geometries, optionally together with round particles, makes it possible to achieve a high density of the sintered bond formed from the starting material.

The starting material is preferably provided as a paste. The viscosity of the paste can be set mainly by means of the solvent added. It is likewise advantageous to provide the starting material in the form of a pellet or as a shaped body, in particular as a flat shaped body. In this case, the paste-like starting material is introduced into a mold or applied to a film. The solvent is subsequently driven off from the starting material by means of a thermal treatment. Here, a solvent which can be driven off without leaving a residue at a temperature below the actual sintering temperature of the starting material should be provided. The starting material formed in this way can also be manufactured in the form of a large sheet which is then cut into small shaped bodies for the particular application.

The first, the second and the further coating of the first, second and/or further particles present in the starting material can in principle be applied by means of known coating processes. These may be found in the known technical literature. Examples which may be mentioned are chemical and physical coating processes such as chemical or physical vapor deposition.

Experiments to date show that the sintered bond formed from the starting material of the invention can attain the electrical conductivity of pure silver, but has at least an electrical conductivity which is only slightly below that of pure silver. In addition, the sintered bond formed has a thermal conductivity of >100 W/mK.

The invention further provides a process for forming a thermally and/or electrically conductive sintered bond. Here, a starting material of the above-described type is used and is introduced between two join partners. Preferred join partners are electrical and/or electronic components having contact points which are brought into direct physical contact with the starting material. Here, the starting material can be applied in the form of a printing paste, for example by means of screen printing or stenciling. Application by ink jet or dispensing processes is likewise possible. A further very simple possibility is to arrange the starting material as shaped body between the join partners.

The sintered bond is subsequently formed by thermal treatment of the starting material. When heat is supplied, the organic metal compound or the noble metal oxide of which at least some is present in the starting material and the reducing agent present in the first coating react with one another. This is a reduction process in which the organic metal compound present in the second coating and/or the noble metal oxide are/is reduced to the parent elemental metal and/or noble metal.

The reduction process advantageously commences at below the sintering temperature of the elemental metal and/or noble metal. A processing temperature of <400° C., preferably <300° C., in particular <250° C., is therefore provided. To improve the sintering process, this is optionally carried out under pressure. A pressure of <4 MPa, preferably <1.6 MPa, particularly preferably <0.8 MPa, is employed as process pressure. Excess reducing agent is completely burnt out providing sufficient oxygen is supplied, for example under an air atmosphere. Join partners are preferably provided with contact points composed of a noble metal, for example gold, silver or an alloy of gold or silver.

In an alternative variant of the process of the invention, the sintered bond is formed under reduced pressure and/or under a nitrogen atmosphere. Since excess reducing agent cannot be burnt out in this case, a starting material having first and second particles, in which the organic metal compound and/or noble metal oxide in the second coating is present in a stoichiometric ratio to the reducing agent present in the first coating, should be provided. During the thermal treatment, the reducing agent is accordingly completely consumed. In addition, the organic metal compound and/or the noble metal oxide are completely converted into the elemental metal and/or noble metal. In this process variant, join partners having a contact point which does not contain noble metal and is instead composed, for example, of copper can advantageously also be provided. This enables inexpensive electrical and/or electronic components also to be employed. Furthermore, dispensing with a process pressure which is otherwise necessary means that the electrical and/or electronic components provided are not subjected to mechanical stresses.

### BRIEF DESCRIPTION OF THE DRAWINGS

Further advantages, features and details of the invention may be derived from the following description of preferred illustrative embodiments and with the aid of the drawings. In the drawings:

FIG. 1 schematically shows first and second particles of a starting material according to the invention for a sintered bond,

FIG. 2a schematically shows a mixture of particles in a starting material according to the invention having first and second particles corresponding to FIG. 1 and further particles composed of silicon,

FIG. 2b schematically shows a further mixture of particles in a starting material according to the invention having particles corresponding to FIG. 1 and further particles composed of tin,

FIG. 3 schematically shows a sectional view of a sintering oven and an electronic circuit arranged in the sintering oven, where the electronic circuit has a starting material according to the invention between a chip and a substrate.

### DETAILED DESCRIPTION

In the figures, identical components and components having the same function are characterized by the same reference numerals.

FIG. 1 schematically shows first particles 10 and second particles 20 which are provided in a starting material according to the invention for a sintered bond in a first embodiment. The particles 10 are composed of silver and have a first coating 11 which contains a reducing agent. Specifically, the coating 11 consists of a fatty acid in this example. Furthermore, it is shown that the second particles 20 comprise a metallic core 22 and a second coating 21 applied to the metallic core 22. The coating 21 contains at least a proportion of an organic metal compound and/or a noble metal oxide. In the present example, the core 22 of the second particles 20 is composed of silver. This is then preferably completely enclosed by a thin coating 21 of Ag₂CO₃, Ag₂O or AgO. The proportion of fatty acid on the first particles 10 is selected so that it is present in a stoichiometric ratio to the organic metal compound composed of Ag₂CO₃, Ag₂O or AgO present in the second coating 21 of the second particles 20. The first particles 10 having the first coating 11 composed of a fatty acid and the second particles 20 are present in, for example, dispersed form, for example as paste.

A starting material according to the invention can optionally contain further particles in addition to the first particles 10 having the first coating 11 and the second particles 20 corresponding to FIG. 1.

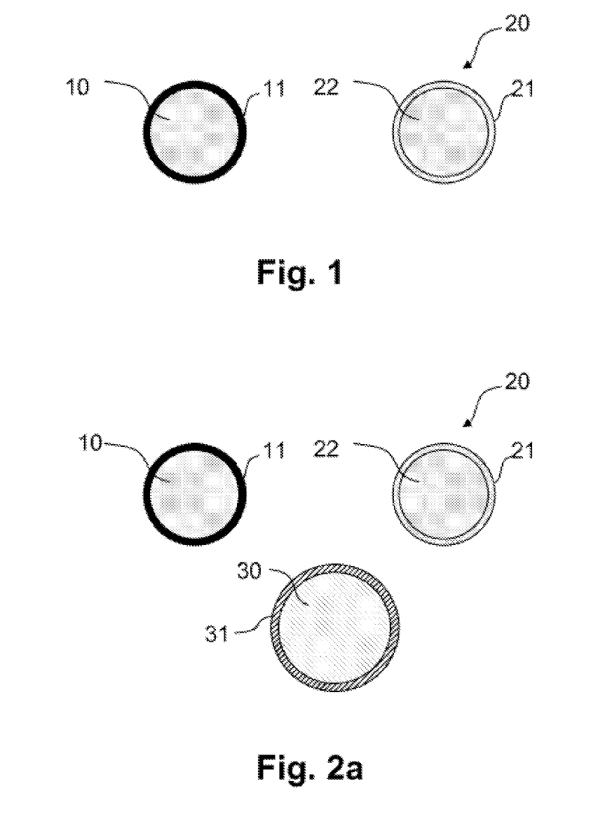

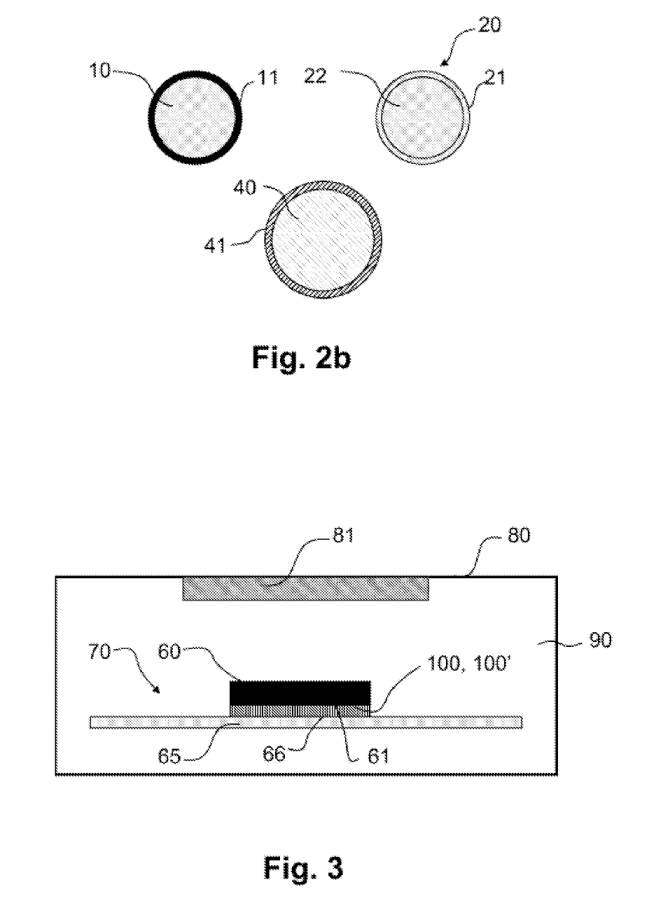

Thus, FIG. 2a shows by way of example a mixture of particles which can be present in a starting material according to the invention. The mixture has first particles 10 having a first coating 11 and second particles 20 corresponding to FIG. 1 and additionally further particles 30 composed of silicon. The further particles 30 are additionally provided with a further coating 31 composed of a silver compound.

FIG. 2b schematically shows a further mixture of particles which is preferably provided in a starting material. Here, in addition to first particles 10 having a first coating 11 and second particles 20 corresponding to FIG. 1, additionally further particles 40 composed of tin are present as a mixture. Furthermore, a further coating 41 composed of a silver compound is provided on the further particles 40 composed of tin.

The first particles 10, second particles 20 and/or further particles 30 or 40 present in the starting material have a particle size of 0.01-50 μm. The first and second particles 10 and 20 are preferably smaller than the further particles 30 or 40, for example having a diameter of 0.1-10 μm.

FIG. 3 shows a sintering oven 80 and also an electronic circuit 70 arranged in a process space 90 of the sintering oven 80. The electronic circuit 70 has a substrate 65 having at least a first contact point 66 composed of copper. A chip 60 having at least one second contact point 61 composed of a silver alloy is arranged on the substrate 65. Between the at least first contact point 66 composed of copper and the at least second contact point 61 composed of the silver alloy, a starting material 100 according to the invention has been applied as a paste. The starting material 100 contains a proportion of a mixture of particles 10, 20, 30 or 10, 20, 40 corresponding to FIGS. 2a and 2b.

To form a sintered bond 100′ between the at least first contact point 66 of the substrate 65 and the at least second contact point 61 of the chip 60, the electronic circuit 70 with the starting material 100 present therein is subjected to a thermal treatment. To carry out the thermal treatment, the sintering oven 80 contains a heating device within the process space 90. A vacuum or a protective gas atmosphere, for example, is present in the process space 90 during the thermal treatment of the starting material 100.

As a result of the thermal treatment of the electronic circuit 70, chemical reaction processes are triggered in the starting material 100. Thus, a reduction process is started in the starting material 100 by means of the fatty acid present as first coating 11 on the first particles 10. In this, the fatty acid acts as a reducing agent which reduces the organic metal compound composed of Ag₂CO₃, Ag₂O and/or AgO present within the second coating 21 of the second particles 20 to elemental silver. This reduction occurs at a temperature below the sintering temperature of silver.

As a result of the stoichiometric ratio of the fatty acid present as first coating 11 on the first particules 10 to the proportion of organic metal compound composed of Ag₂O₃, Ag₂O or AgO present in the second coating 21 of the particles 20, the second coating 21 is largely completely converted into silver. In addition, virtually no residues of fatty acid remain in the sintered bond 100′ formed; otherwise, in the case of a residual amount of <1%, this residue would have to be burnt out with introduction of oxygen.

The metallic core 22 of the second particles 20 sinters with the second coating 21 which is arranged on the core 22 and has been converted into silver and forms a silver matrix as part of the sintered microstructure of the sintered bond 100′ which forms. In addition, the first particles 10 composed of silver are also concomitantly sintered in the silver matrix. Likewise, contacting of the first and second contact points 61, 66 of the substrate and chip 65 is effected by means of the sintered bond 100′ formed. Contacting of the first contact point 66 composed of copper during the thermal treatment is possible without corrosion phenomena since contacting is carried out in vacuo or under a protective gas atmosphere. As a result, a non-noble material, for example composed of copper, also remains free of oxidation products during the thermal treatment to form the sintered bond 100′.

The further particles 40 composed of tin which are present as a mixture with the first and second particles 10 and 20 in the starting material 100 melt at an early stage during the thermal treatment and aid intimate contact of all particles 10, 20, 30, 40 present in the starting material 100. In addition, the tin of the further particles 40 forms alloys with the silver of the silver matrix formed. These alloys are then present as ductile phases within the silver matrix formed in the sintered microstructure.

The further particles 30 composed of silicon which are likewise present as a mixture in the starting material 100 are inert during the sintering process. Here, the further coating 31 composed of the silver compound which has been applied to the further particles 30 aids sintering within the sintered microstructure. The further particles 30 composed of silicon are finely dispersed within the silver matrix of the sintered microstructure 100′ after formation of the sintered bond 100′.

1. A starting material for a sintered bond (100′), which comprises first particles (10) composed of at least one metal having a first coating (11) which is applied to the first particles (10) and is composed of an organic material, and second particles (20) which contain an organic metal compound and/or or a noble metal oxide, where the organic metal compound and/or the noble metal oxide are converted in a thermal treatment of the starting material (100) into the parent elemental metal and/or noble metal,
characterized in that
the second particles (20) comprise a core (22) of at least one metal, and a second coating (21) which is applied to the core (22) and contains the organic metal compound and/or the noble metal oxide, and in that the first coating (11) contains a reducing agent by means of which the organic metal compound and/or the noble metal oxide are reduced to the elemental metal and/or noble metal at a temperature below the sintering temperature of the elemental metal and/or noble metal.

2. The starting material as claimed in claim 1, characterized in that the first particles (10) and/or the metallic core (22) of the second particles (20) contains a noble metal.

3. The starting material as claimed in claim 2, characterized in that the first particles (10) and/or the metallic core (22) of the second particles (20) contain silver, gold, platinum, palladium and/or copper.

4. The starting material as claimed in claim 1, characterized in that the first coating (11) comprises at least one alcohol selected from the group consisting of primary and secondary alcohols, and/or an amine and/or a formic acid.

5. The starting material as claimed in claim 1, characterized in that the organic material present in the first coating (11) is a fatty acid, or in that it is a mixture of various fatty acids.

6. The starting material as claimed in claim 1, characterized in that the organic metal compound present in the second coating (21) is a silver carbonate, a silver lactate, a silver stearate or a sodium carbonate.

7. The starting material as claimed in claim 1, characterized in that the noble metal oxide present in the second coating (21) is a silver oxide.

8. The starting material as claimed in claim 1, characterized in that the proportion of organic metal compound and/or noble metal oxide in the second coating (21) is in a stoichiometric ratio to the proportion of the reducing agent in the first coating (11).

9. The starting material as claimed in claim 1, characterized in that further particles (30, 40) containing an element of the fourth main group of the Periodic Table are additionally provided.

10. The starting material as claimed in claim 9, characterized in that the further particles (30, 40) have a further coating (31, 41) composed of a noble metal or an organic coating.

11. The starting material as claimed in claim 1, characterized in that the first, the second and/or further particles (10, 20, 30, 40) have an average particle size of 0.01-50 μm.

12. A sintered bond derived from a starting material as claimed in claim 1, characterized in that the thermal conductivity of the sintered bond (100′) is >100 W/mK.

13. The sintered bond as claimed in claim 12, characterized in that the sintered bond (100′) contains at least a proportion of a silver-sodium alloy.

14. An electronic circuit having a sintered bond as claimed in claim 12.

15. The electronic circuit as claimed in claim 14, characterized in that the sintered bond (100′) has an electrical, thermal and/or mechanical contact point (61, 66) to at least one electrical or electronic component (60, 65).

16. A process for forming a thermally and/or electrically conductive sintered bond (100′), where a starting material (100) for the sintered bond (100′) as claimed in claim 1 is provided, which comprises the following steps:
provision of the starting material (100),
formation of the sintered bond (100′) by thermal treatment of the starting material (100), where the organic metal compound present in the second coating (21) and/or the noble metal oxide are reduced to the elemental metal and/or noble metal by means of the reducing agent present in the first coating (11) at a temperature below the sintering temperature of the elemental metal and/or the noble metal.

17. The process as claimed in claim 16, characterized in that the sintered bond (100′) is formed at a temperature below 500° C.

18. The sintered bond as claimed in claim 16, characterized in that the sintered bond (100′) is formed under reduced pressure and/or in a nitrogen atmosphere.

19. The process as claimed in claim 16, characterized in that the starting material (100) is in the form of a printing paste.

20. The starting material as claimed in claim 1, characterized in that the organic material present in the first coating (11) is an isostearic acid, a stearic acid, an oleic acid, or a lauric acid, or in that it is a mixture of various fatty acids.

21. The process as claimed in claim 16, characterized in that the sintered bond (100′) is formed at a temperature below 250° C.

22. The process as claimed in claim 16, characterized in that the starting material (100) is in the form of a printing paste for screen printing or stenciling, or for an ink jet application process, or in the form of a shaped part.
